(19) United States
(12) Patent Application Publication
(10) Pub. No.: US 2025/0328524 A1
(43) Pub. Date: Oct. 23, 2025

(54) INTELLIGENT CONTENT GENERATION FOR PROCESS AUTOMATION

(71) Applicant: SAP SE, Walldorf (DE)

(72) Inventors: UWE SCHULZ, Walldorf (DE); Oliver Klemenz, Sinheim (DE)

(21) Appl. No.: 18/642,094

(22) Filed: Apr. 22, 2024

(51) Int. Cl. G06F 16/2452; G06F 16/23

(52) U.S. Cl. CPC G06F 16/24522; G06F 16/2365

(57) ABSTRACT

Arrangements for intelligent content generation for process automation are provided. A domain model, being structured into tasks according to a defined schema, may be exported for processing by a large language model. A prompt and a context window associated with a task of the domain model may be received. A task template associated with the task may be modified. The modified task template may be enriched with data from a backend system. Content validation may be performed on content of the modified task template enriched with the data from the backend system. Schema validation may be performed for validating the modified task template enriched with the data from the backend system against the defined schema. Correction of invalid tasks may be performed in an iterative loop until the modified task template enriched with the data from the backend system is validated. Then, changes to the domain model may be applied.

### TECHNICAL FIELD

The subject matter described herein relates generally to data processing and more specifically to intelligent content generation for process automation.

### BACKGROUND

Oftentimes enterprise processes consist of numerous single steps that must be carried out on a regular basis. These steps might include manual tasks, system or batch processing tasks, and tasks in connected enterprise resource planning backend systems. These steps need to be configured in application systems, such as process automation of enterprise tasks. It may be difficult to create and maintain the required content for a certain enterprise process. Such creation and maintenance requires specialized knowledge, experience, manual effort, and human interaction.

### SUMMARY

Methods, systems, and articles of manufacture, including computer program products, are provided for intelligent content generation for process automation. In one aspect, there is provided a system including at least one processor and at least one memory. The at least one memory can store instructions that cause operations when executed by the at least one processor. The operations may include: exporting a domain model for processing by a large language model, the domain model being structured into tasks according to a defined schema, wherein exporting the domain model comprises generating a text file comprising code that represents structured data; receiving, by the large language model, a prompt and a context window associated with a task of the domain model; modifying, using the large language model, a task template associated with the task; enriching the modified task template with data from a backend system; performing content validation on content of the modified task template enriched with the data from the backend system; performing schema validation for validating the modified task template enriched with the data from the backend system against the defined schema; in response to performing the content validation and the schema validation, correcting invalid tasks, wherein the correcting is repeated and performed recursively until the modified task template enriched with the data from the backend system is validated; and applying changes to the domain model.

In some variations, one or more of the features disclosed herein including the following features can optionally be included in any feasible combination. In some variations, exporting the domain model may include exporting a portion of the domain model including a specific task and a specific field.

In some variations, enriching the modified task template with the data from a backend system may include merging the modified task template with user specific data that is not available to the large language model.

In some variations, the task template may be written in a data interchange format storing data objects and structures.

In some variations, the prompt may include a set of instructions provided to the large language model for receiving a specific response.

In some variations, the operations may further include: in response to performing the content validation and the schema validation: identifying one or more invalidations associated with the modified task template enriched with the data from the backend system; and initiating a display of the one or more invalidations.

In some variations, the operations may further include: prior to applying changes to the domain model, requesting user input for granting or denying a change to the domain model.

In another aspect, there is provided a method for intelligent content generation for process automation. The method may include: exporting a domain model for processing by a large language model, the domain model being structured into tasks according to a defined schema, wherein exporting the domain model comprises generating a text file comprising code that represents structured data; receiving, by the large language model, a prompt and a context window associated with a task of the domain model; modifying, using the large language model, a task template associated with the task; enriching the modified task template with data from a backend system; performing content validation on content of the modified task template enriched with the data from the backend system; performing schema validation for validating the modified task template enriched with the data from the backend system against the defined schema; in response to performing the content validation and the schema validation, correcting invalid tasks, wherein the correcting is repeated and performed recursively until the modified task template enriched with the data from the backend system is validated; and applying changes to the domain model.

In some variations, one or more of the features disclosed herein including the following features can optionally be included in any feasible combination. In some variations, exporting the domain model may include exporting a portion of the domain model including a specific task and a specific field.

In some variations, enriching the modified task template with the data from a backend system may include merging the modified task template with user specific data that is not available to the large language model.

In some variations, the task template may be written in a data interchange format storing data objects and structures.

In some variations, the prompt may include a set of instructions provided to the large language model for receiving a specific response.

In some variations, the operations may further include: in response to performing the content validation and the schema validation: identifying one or more invalidations associated with the modified task template enriched with the data from the backend system; and initiating a display of the one or more invalidations.

In some variations, the operations may further include: prior to applying changes to the domain model, requesting user input for granting or denying a change to the domain model.

In another aspect, there is provided a computer program product that includes a non-transitory computer readable medium. The non-transitory computer readable medium may store instructions that cause operations when executed by at least one processor. The operations may include: exporting a domain model for processing by a large language model, the domain model being structured into tasks according to a defined schema, wherein exporting the domain model comprises generating a text file comprising code that represents structured data; receiving, by the large language model, a prompt and a context window associated with a task of the domain model; modifying, using the large language model, a task template associated with the task; enriching the modified task template with data from a backend system; performing content validation on content of the modified task template enriched with the data from the backend system; performing schema validation for validating the modified task template enriched with the data from the backend system against the defined schema; in response to performing the content validation and the schema validation, correcting invalid tasks, wherein the correcting is repeated and performed recursively until the modified task template enriched with the data from the backend system is validated; and applying changes to the domain model.

In some variations, one or more of the features disclosed herein including the following features can optionally be included in any feasible combination. In some variations, exporting the domain model may include exporting a portion of the domain model including a specific task and a specific field.

In some variations, enriching the modified task template with the data from a backend system may include merging the modified task template with user specific data that is not available to the large language model.

In some variations, the task template may be written in a data interchange format storing data objects and structures.

In some variations, the prompt may include a set of instructions provided to the large language model for receiving a specific response.

In some variations, the operations may further include: in response to performing the content validation and the schema validation: identifying one or more invalidations associated with the modified task template enriched with the data from the backend system; and initiating a display of the one or more invalidations.

In some variations, the operations may further include: prior to applying changes to the domain model, requesting user input for granting or denying a change to the domain model.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an illustrative computing environment for intelligent content generation for process automation in accordance with some example embodiments;

FIG. 2 depicts a flowchart illustrating a process for intelligent content generation for process automation in accordance with some example embodiments;

FIG. 3 depicts a block flow diagram illustrating a process for intelligent content generation for process automation in accordance with some example embodiments; and

FIG. 4 depicts a block diagram illustrating a computing system, in accordance with some example embodiments.

When practical, similar reference numbers denote similar structures, features, or elements.

### DETAILED DESCRIPTION

Aspects of the disclosure provide a technical solution that addresses problems associated with intelligent content generation for process automation based on generative artificial intelligence. Additional aspects of the disclosure provide for the analysis of system and user behavior combined with enterprise knowledge and custom data to generate tailored proposals for automation content that can be used for implementation in automation solutions. Further aspects of the disclosure may generate a template (e.g., a task template comprising definitions of tasks having a particular order) for automation of process steps that may be used by automation solutions. Validation steps may be performed on the schema level and on the data level to conform to execution backends. Further aspects of the disclosure establishes a correction loop to correct validation errors is established, allowing to correct generated data in a reiterative approach. These and various other arrangements will be discussed more fully below.

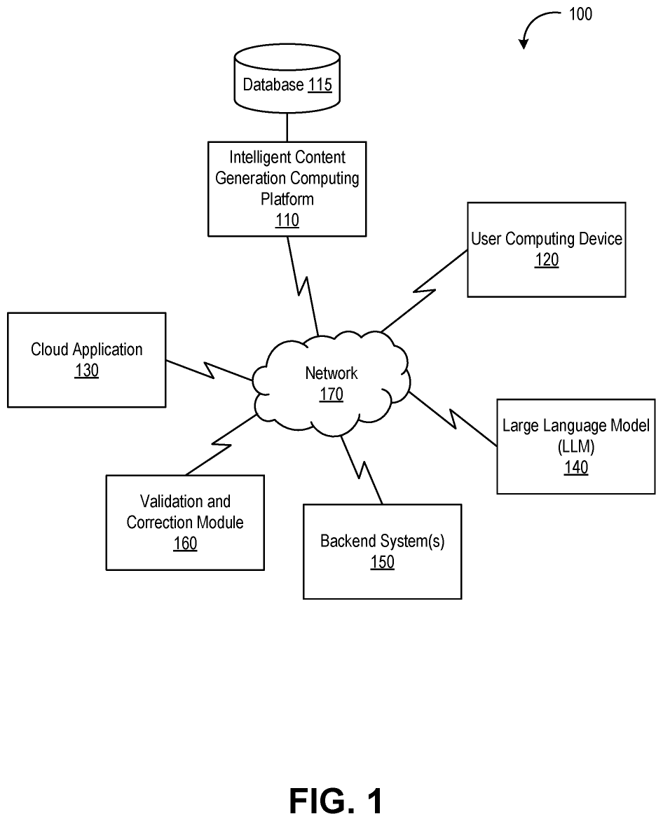

FIG. 1 depicts an illustrative computing environment 100 for intelligent content generation for process automation based on generative artificial intelligence in accordance with some example embodiments. Referring to FIG. 1, the computing environment 100 may include one or more computing devices and/or other computing systems. For example, computing environment 100 may include an intelligent content generation computing platform 110, a database 115, a user computing device 120, a cloud application 130, a large language model (LLM) 140, one or more backend systems 150, and a validation and correction module 160. intelligent content generation computing platform 110 may include one or more computing devices configured to perform one or more of the functions described herein. In some examples, intelligent content generation computing platform 110 may, generate an intermediate representation (JSON) of a data model, perform adjustments to the JSON structure according to an engineered prompt, send the prompt and JSON file to a large language model (LLM) as inputs, adjusted and extending the JSON file according to the engineered prompt, fulfilling the use case requirements. Database 115 may include, for example, a relational database, an in-memory database, a graph database, a key-value store, a document store, and/or the like. In some examples, the intelligent content generation computing platform 110 may maintain (e.g., store) various types of data, including static and nonstatic data (e.g., system data, customizing data, master data, application data, log data, and/or the like) in one or more database tables at a database 115 coupled with the intelligent content generation computing platform 110.

User computing device 120 may be a processor-based device including, for example, a smartphone, a tablet computer, a wearable apparatus, a virtual assistant, an Internet-of-Things (IoT) appliance, and/or the like. Cloud application 130 may be a cloud-based system hosted on one or more cloud-computing platforms. Large language model 140 may be a generative artificial intelligence model for performing generative artificial intelligence operations. Large language model 140 includes a type of machine learning model that may perform a variety of natural language processing tasks including generating and classifying text, answering questions in a conversational manner, and translating text. Backend system(s) 150 may include an application server and a database server, which may host application logic and metadata. Validation and correction module 160 may check and verify the semantically correct state of technical and business context and correct the data to ensure integrity before further processing.

Referring again to FIG. 1, the intelligent content generation computing platform 110, the database 115, the user computing device 120, the cloud application 130, the large language model 140, the one or more backend systems 150, and the validation and correction module 160 may be communicatively coupled via a network 170. The network 170 may be a wired and/or wireless network including, for example, a wide area network (WAN), local area network (LAN), a virtual local area network (VLAN), the Internet, and/or the like.

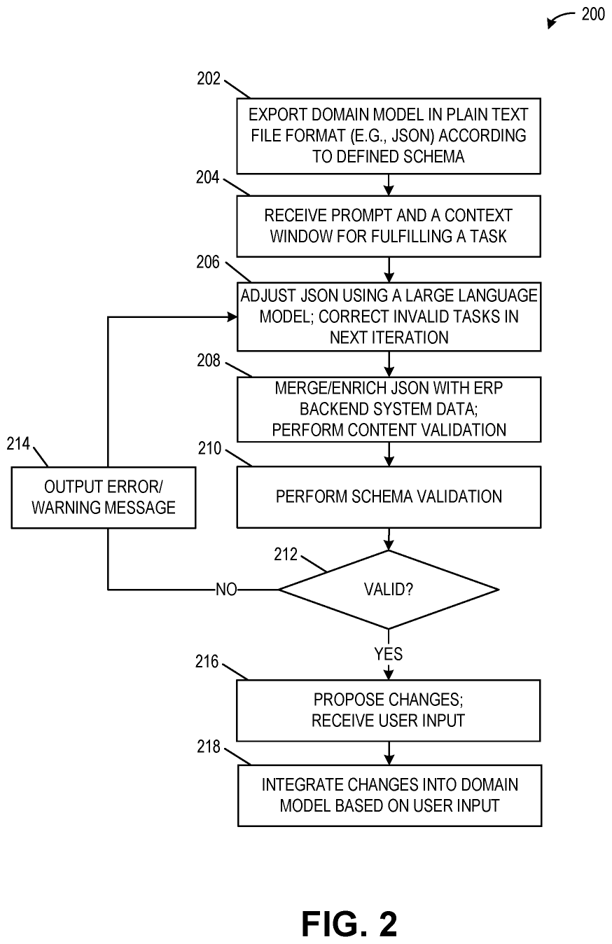

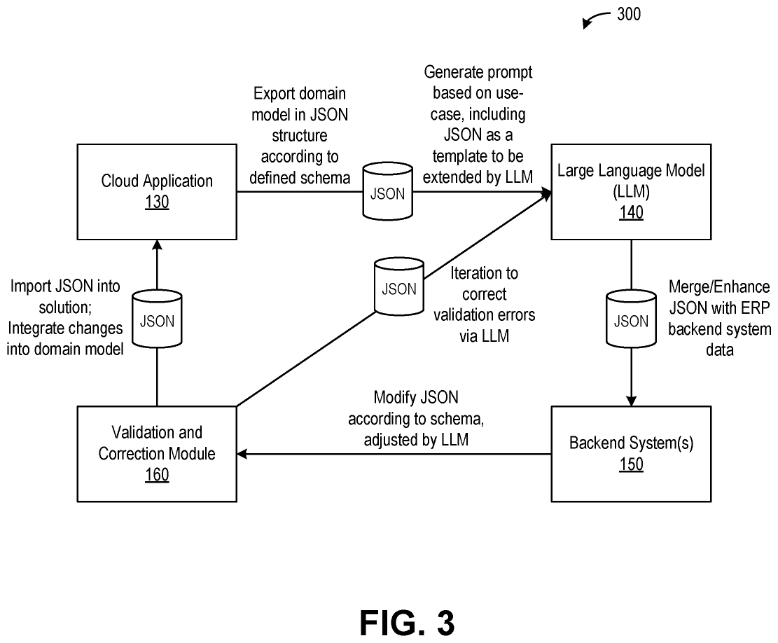

FIGS. 2 and 3 will be discussed together. FIG. 2 depicts a flowchart 200 illustrating a process for intelligent content generation for process automation, in accordance with some example embodiments. FIG. 3 depicts a block flow diagram 300 illustrating a process for intelligent content generation for process automation in accordance with some example embodiments, with reference to the steps in FIG. 2.

Referring to FIGS. 2 and 3, at step 202, intelligent content generation computing platform 110 (e.g., via cloud application 130) may export a domain model for processing by a large language model (e.g., large language model 140). The domain model may be structured into tasks according to a defined schema. The structure data may be exported as part of a JSON file, rather than being held in database relations which the large language model would not have access to. For example, intelligent content generation computing platform 110 may generate and export a text file comprising code that represents structured data (e.g., a JSON file). In some examples, the data model may be partially extracted and formalized into a JSON format to be processed by the LLM 140. For example, intelligent content generation computing platform 110 may export, to the large language model, a portion or part of the domain model including a specific task and a specific field (e.g., without exporting the other fields). Other exchange formats may be contemplated.

At step 204, intelligent content generation computing platform 110 may receive, by the large language model (e.g., large language model 140), a prompt and a context window associated with a task of the domain model (e.g., based on a use case). The prompt may include a set of instructions provided to the large language model for receiving a specific response. The context window may include an amount of text or tokens that the large language model considers when generating the response. For example, a prompt may be generated for the LLM 140 to follow, instructing the LLM 140 to manipulate the JSON file and perform a specific task (e.g., replace an element in the JSON file or adding an element to the JSON file, while adhering to the defined schema). In the context of task user assignments, an example prompt may be: “Replace responsible with name ‘A’ with ‘B’ in input JSON,” and the LLM may adjust the JSON and replace the responsible user from ‘A’ to ‘B.’ In the context of hierarchical task generation, an example prompt may be: “Add for each company code a new Task for to run the program Z_CLOSE,” and the LLM may adjust the JSON and insert, for each company code folder, a task with reference to program Z_CLOSE.

At step 206, intelligent content generation computing platform 110 may modify, using the large language model (e.g., large language model 140), a task template (or task list template) associated with the task. The task template may be written in a data interchange format storing data objects and structures (e.g., in JSON structure). Task list templates may describe a hierarchical structure of folders and tasks. Folders may correlate to organizational units (e.g., company codes) so that corresponding tasks are relevant for that organizational unit. Tasks may have dependencies to formulate an execution order. The task list template may include, for example, tasks IDs and current responsible user(s) in the context of task user assignments, or folder/task hierarchies in the context of hierarchical task generation.

At step 208, intelligent content generation computing platform 110 may enrich (e.g., merge or enhance) the modified task template with data from a backend system (e.g., backend system 150). For example, intelligent content generation computing platform 110 may merge the modified task template with user specific data that is not available to the large language model (e.g., a customer specific data sets, master-data references, business configurations, program parameters, etc.). In addition, at step 208, intelligent content generation computing platform 110 may perform content validation on content of the modified task template enriched with the data from the backend system (e.g., to verify that the data meets certain criteria, rules, or logic) for ensuring accuracy and completeness of data.

At step 210, intelligent content generation computing platform 110 may perform schema validation (e.g., via validation and correction module 160) for validating the modified task template enriched with the data from the backend system (e.g., backend system 150) against the defined schema (e.g., to verify that the data conforms to a predefined structure, format, and type) to ensure consistency and compatibility of data cross different sources, platforms, or applications. For instance, in the context of task user assignments, responsible parties for a task may be validated in an automation system. In another instance, in the context of hierarchical task generation, a folder/task hierarchy may be checked for consistency and missing data.

At step 212, in response to performing the content validation and the schema validation, intelligent content generation computing platform 110 may identify one or more invalidations associated with the modified task template enriched with the data from the backend system (e.g., step 212: NO), and initiate a display of the one or more invalidations at step 214 (e.g., an error or warning message). For example, an error or warning may be displayed to an end user computing device (e.g., user computing device 120) if a JSON violates gatekeeper validation (even after correction iteration) (e.g., person B cannot process a task due to missing the required authorizations). The process may return to step 206, in which intelligent content generation computing platform 110 (e.g., via the large language model 140) may correct invalid tasks. In some example, the correcting may be repeated and performed recursively (e.g., in an iterative loop) until the modified task template enriched with the data from the backend system is validated.

At step 216, in some embodiments, prior to applying changes to the domain model, intelligent content generation computing platform 110 may request user input for granting or denying a change to the domain model. For example, users may provide authorization, or request an adjusted format or a different solution from the intelligent content generation computing platform 110.

At step 218, intelligent content generation computing platform 110 may apply or otherwise integrate changes to the domain model including the task list or task list template. For example, a template layout may apply to all future tasks or a modification may be made to a particular period (e.g., month-end, year-end, etc.). In this way, users would not need to work manually through a hierarchy of tasks to make adjustments.

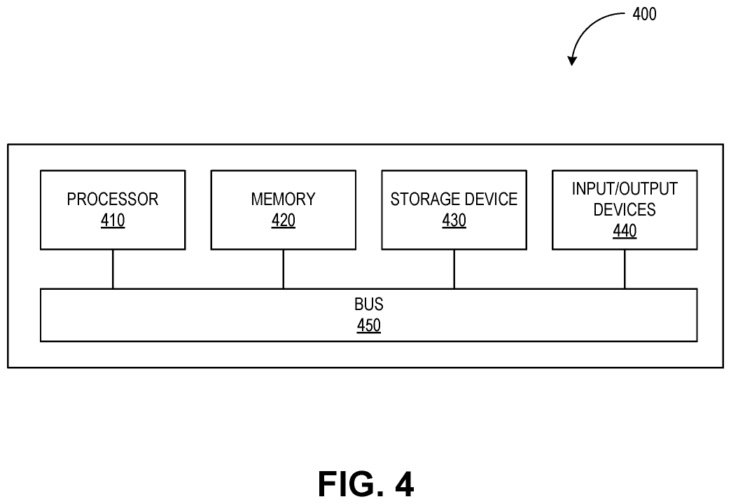

FIG. 4 depicts a block diagram illustrating a computing system 400 consistent with implementations of the current subject matter. Referring to FIGS. 1-4, the computing system 400 can be used to implement the intelligent content generation computing platform 110 and/or any components therein.

As shown in FIG. 4, the computing system 400 can include a processor 410, a memory 420, a storage device 430, and input/output devices 440. The processor 410, the memory 420, the storage device 430, and the input/output devices 440 can be interconnected via a system bus 450. The processor 410 is capable of processing instructions for execution within the computing system 400. Such executed instructions can implement one or more components of, for example, the intelligent content generation computing platform 110. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a solid-state device, a floppy disk device, a hard disk device, an optical disk device, a tape device, and/or any other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising:
at least one processor; and
at least one memory storing instructions, which when executed by the at least one processor, result in operations comprising:
   exporting a domain model for processing by a large language model, the domain model being structured into tasks according to a defined schema, wherein exporting the domain model comprises generating a text file comprising code that represents structured data;
   receiving, by the large language model, a prompt and a context window associated with a task of the domain model;
   modifying, using the large language model, a task template associated with the task;
   enriching the modified task template with data from a backend system;
   performing content validation on content of the modified task template enriched with the data from the backend system;
   performing schema validation for validating the modified task template enriched with the data from the backend system against the defined schema;
   in response to performing the content validation and the schema validation, correcting invalid tasks, wherein the correcting is repeated and performed recursively until the modified task template enriched with the data from the backend system is validated; and
   applying changes to the domain model.

Example 2: The system of Example 1, wherein exporting the domain model comprises exporting a portion of the domain model including a specific task and a specific field.

Example 3: The system of any of Examples 1-2, wherein enriching the modified task template with the data from a backend system comprises merging the modified task template with user specific data that is not available to the large language model.

Example 4: The system of any of Examples 1-3, wherein the task template is written in a data interchange format storing data objects and structures.

Example 5: The system of any of Examples 1-4, wherein the prompt comprises a set of instructions provided to the large language model for receiving a specific response.

Example 6: The system of any of Examples 1-5, further comprising, in response to performing the content validation and the schema validation:
identifying one or more invalidations associated with the modified task template enriched with the data from the backend system; and
initiating a display of the one or more invalidations.

Example 7: The system of any of Examples 1-6, further comprising: prior to applying changes to the domain model, requesting user input for granting or denying a change to the domain model.

Example 8: A computer-implemented method comprising:
exporting a domain model for processing by a large language model, the domain model being structured into tasks according to a defined schema, wherein exporting the domain model comprises generating a text file comprising code that represents structured data;
receiving, by the large language model, a prompt and a context window associated with a task of the domain model;
modifying, using the large language model, a task template associated with the task;
enriching the modified task template with data from a backend system;
performing content validation on content of the modified task template enriched with the data from the backend system;
performing schema validation for validating the modified task template enriched with the data from the backend system against the defined schema;
in response to performing the content validation and the schema validation, correcting invalid tasks, wherein the correcting is repeated and performed recursively until the modified task template enriched with the data from the backend system is validated; and
applying changes to the domain model.

Example 9: The computer-implemented method of Example 8, wherein exporting the domain model comprises exporting a portion of the domain model including a specific task and a specific field.

Example 10: The computer-implemented method of any of Examples 8-9, wherein enriching the modified task template with the data from a backend system comprises merging the modified task template with user specific data that is not available to the large language model.

Example 11: The computer-implemented method of any of Examples 8-10, wherein the task template is written in a data interchange format storing data objects and structures.

Example 12: The computer-implemented method of any of Examples 8-11, wherein the prompt comprises a set of instructions provided to the large language model for receiving a specific response.

Example 13: The computer-implemented method of any of Examples 8-12, further comprising, in response to performing the content validation and the schema validation:
identifying one or more invalidations associated with the modified task template enriched with the data from the backend system; and
initiating a display of the one or more invalidations.

Example 14: The computer-implemented method of any of Examples 8-13, further comprising: prior to applying changes to the domain model, requesting user input for granting or denying a change to the domain model.

Example 15: A non-transitory computer-readable medium storing instructions, which when executed by at least one processor, result in operations comprising:
exporting a domain model for processing by a large language model, the domain model being structured into tasks according to a defined schema, wherein exporting the domain model comprises generating a text file comprising code that represents structured data;
receiving, by the large language model, a prompt and a context window associated with a task of the domain model;
modifying, using the large language model, a task template associated with the task;
enriching the modified task template with data from a backend system;
performing content validation on content of the modified task template enriched with the data from the backend system;
performing schema validation for validating the modified task template enriched with the data from the backend system against the defined schema;
in response to performing the content validation and the schema validation, correcting invalid tasks, wherein the correcting is repeated and performed recursively until the modified task template enriched with the data from the backend system is validated; and
applying changes to the domain model.

Example 16: The non-transitory computer-readable medium of Example 15, wherein exporting the domain model comprises exporting a portion of the domain model including a specific task and a specific field.

Example 17: The non-transitory computer-readable medium any of Examples 15-16, wherein enriching the modified task template with the data from a backend system comprises merging the modified task template with user specific data that is not available to the large language model.

Example 18: The non-transitory computer-readable medium any of Examples 15-17, wherein the task template is written in a data interchange format storing data objects and structures.

Example 19: The non-transitory computer-readable medium any of Examples 15-18, further comprising, in response to performing the content validation and the schema validation: identifying one or more invalidations associated with the modified task template enriched with the data from the backend system; and initiating a display of the one or more invalidations.

Example 20: The non-transitory computer-readable medium any of Examples 15-19, prior to applying changes to the domain model, requesting user input for granting or denying a change to the domain model.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one processor; and
at least one memory storing instructions, which when executed by the at least one processor, result in operations comprising:
exporting a domain model for processing by a large language model, the domain model being structured into tasks according to a defined schema, wherein exporting the domain model comprises generating a text file comprising code that represents structured data;
receiving, by the large language model, a prompt and a context window associated with a task of the domain model;
modifying, using the large language model, a task template associated with the task;
enriching the modified task template with data from a backend system;
performing content validation on content of the modified task template enriched with the data from the backend system;
performing schema validation for validating the modified task template enriched with the data from the backend system against the defined schema;
in response to performing the content validation and the schema validation, correcting invalid tasks, wherein the correcting is repeated and performed recursively until the modified task template enriched with the data from the backend system is validated; and
applying changes to the domain model.

2. The system of claim 1, wherein exporting the domain model comprises exporting a portion of the domain model including a specific task and a specific field.

3. The system of claim 1, wherein enriching the modified task template with the data from a backend system comprises merging the modified task template with user specific data that is not available to the large language model.

4. The system of claim 1, wherein the task template is written in a data interchange format storing data objects and structures.

5. The system of claim 1, wherein the prompt comprises a set of instructions provided to the large language model for receiving a specific response.

6. The system of claim 1, further comprising, in response to performing the content validation and the schema validation:
identifying one or more invalidations associated with the modified task template enriched with the data from the backend system; and
initiating a display of the one or more invalidations.

7. The system of claim 1, further comprising: prior to applying changes to the domain model, requesting user input for granting or denying a change to the domain model.

8. A computer-implemented method comprising:
exporting a domain model for processing by a large language model, the domain model being structured into tasks according to a defined schema, wherein exporting the domain model comprises generating a text file comprising code that represents structured data;
receiving, by the large language model, a prompt and a context window associated with a task of the domain model;
modifying, using the large language model, a task template associated with the task;
enriching the modified task template with data from a backend system;
performing content validation on content of the modified task template enriched with the data from the backend system;
performing schema validation for validating the modified task template enriched with the data from the backend system against the defined schema;
in response to performing the content validation and the schema validation, correcting invalid tasks, wherein the correcting is repeated and performed recursively until the modified task template enriched with the data from the backend system is validated; and
applying changes to the domain model.

9. The computer-implemented method of claim 8, wherein exporting the domain model comprises exporting a portion of the domain model including a specific task and a specific field.

10. The computer-implemented method of claim 8, wherein enriching the modified task template with the data from a backend system comprises merging the modified task template with user specific data that is not available to the large language model.

11. The computer-implemented method of claim 8, wherein the task template is written in a data interchange format storing data objects and structures.

12. The computer-implemented method of claim 8, wherein the prompt comprises a set of instructions provided to the large language model for receiving a specific response.

13. The computer-implemented method of claim 8, further comprising, in response to performing the content validation and the schema validation:
identifying one or more invalidations associated with the modified task template enriched with the data from the backend system; and
initiating a display of the one or more invalidations.

14. The computer-implemented method of claim 8, further comprising: prior to applying changes to the domain model, requesting user input for granting or denying a change to the domain model.

15. A non-transitory computer readable medium storing instructions, which when executed by at least one processor, result in operations comprising:
exporting a domain model for processing by a large language model, the domain model being structured into tasks according to a defined schema, wherein exporting the domain model comprises generating a text file comprising code that represents structured data;
receiving, by the large language model, a prompt and a context window associated with a task of the domain model;
modifying, using the large language model, a task template associated with the task;
enriching the modified task template with data from a backend system;
performing content validation on content of the modified task template enriched with the data from the backend system;
performing schema validation for validating the modified task template enriched with the data from the backend system against the defined schema;
in response to performing the content validation and the schema validation, correcting invalid tasks, wherein the correcting is repeated and performed recursively until the modified task template enriched with the data from the backend system is validated; and
applying changes to the domain model.

16. The non-transitory computer readable medium of claim 15, wherein exporting the domain model comprises exporting a portion of the domain model including a specific task and a specific field.

17. The non-transitory computer readable medium of claim 15, wherein enriching the modified task template with the data from a backend system comprises merging the modified task template with user specific data that is not available to the large language model.

18. The non-transitory computer readable medium of claim 15, wherein the task template is written in a data interchange format storing data objects and structures.

19. The non-transitory computer readable medium of claim 15, wherein the instructions, when executed by the at least one processor, further result in operations comprising, in response to performing the content validation and the schema validation:
identifying one or more invalidations associated with the modified task template enriched with the data from the backend system; and
initiating a display of the one or more invalidations.

20. The non-transitory computer readable medium of claim 15, prior to applying changes to the domain model, requesting user input for granting or denying a change to the domain model.
